(19) United States
(12) Patent Application Publication
(10) Pub. No.: US 2022/0219345 A1
(43) Pub. Date: Jul. 14, 2022

(54) METHOD OF MANUFACTURING A GUARD ELEMENT FOR USE IN A HAIR-CUTTING UNIT

(71) Applicant: KONINKLIJKE PHILIPS N.V., EINDHOVEN (NL)

(72) Inventor: Gerrit KLASEBOER, STEENWIJK (NL)

(21) Appl. No.: 17/606,852

(22) PCT Filed: May 1, 2020
(86) PCT No.: PCT/EP2020/062192

§ 371 Date: Oct. 27, 2021

(30) Foreign Application Priority Data
May 8, 2019 (EP) 19173216.3

(51) Int. Cl. B26B 19/38; B26B 19/14; B21D 35/00; B21D 28/26; B21D 22/00

(52) U.S. Cl. CPC B26B 19/384; B26B 19/143; B21D 22/00; B21D 28/26; B21D 35/002

(57) ABSTRACT

A method of manufacturing a guard element is configured to be used in a hair-cutting unit and which is of a design including a shaving track with hair-entry apertures where the shaving track has a thickness profile with at least one thickness value. According to the manufacturing method, a sheet is proviced, and the thickness profile of the shaving track according to the design of the guard element is realized in the sheet at a position where the shaving track is to be formed. Subsequently, material is removed from the sheet at the position where the shaving track is to be formed so as to create the hair-entry apertures.

### FIELD OF THE INVENTION

The invention relates to a method of manufacturing a guard element which is configured to be used in a hair-cutting unit as a guard for a movable hair-cutting element of the hair-cutting unit, and which is of a design including a shaving track with a plurality of hair-entry apertures.

Further, the invention relates to a method of manufacturing a hair-cutting unit which comprises a guard element and a movable hair-cutting element at least partially arranged in an interior space of the guard element, and also to a method of manufacturing a hair-cutting appliance which comprises a body for a user of the hair-cutting appliance to take hold of and a head including at least one hair-cutting unit.

### BACKGROUND OF THE INVENTION

The invention is in the field of hair-cutting appliances, particularly hair-cutting appliances which are designed to perform shaving actions and the like in which hairs are cut at a position close to the skin. In general, a hair-cutting appliance comprises a head where one or more hair-cutting units are located. A particularly common design uses three hair-cutting units in an equilateral triangular configuration. Each hair-cutting unit comprises a movable hair-cutting element and a guard element. The guard element is provided with a series of hair-entry apertures. For example, in the practical case that the guard element is generally cup-shaped and has a substantially circular periphery, the hair-entry apertures may be shaped like elongated slots extending substantially radially with respect to a central axis of the guard element, in one or more annular areas referred to as shaving tracks.

The guard element has an outer surface for contacting the skin at the position of the shaving track(s) during a hair-cutting action and an inner surface which is contacted by the hair-cutting element at the position of the shaving track(s). At positions where the hair-entry apertures are delimited, cutting surfaces are present in the guard element. The hair-cutting element includes blades having cutting edges. During a hair-cutting action, hairs entering the hair-entry apertures are sheared between the cutting surfaces and the cutting edges, and are cut as a result thereof. Proper use of the hair-cutting appliance involves putting the appliance to an active state, i.e. a state in which the hair-cutting element of the at least one hair-cutting unit is moved, and moving the head over a skin area which is to be subjected to a hair-cutting action.

JP H08 141228 A discloses a method of manufacturing a guard element which is configured to be used as an outer hair-cutting element of an electric shaving device. The outer hair-cutting element has a plurality of slit-shaped hair-entry openings provided in an annular shaving track of the outer hair-cutting element. In a first series of manufacturing steps, a plate is punched and pressed to form a disk, and the disk is drawn and pressed so as to assume a three-dimensional shape having said annular shaving track. In a second manufacturing step, a thickness of the annular shaving track is reduced by removing material from the inner surface of the annular shaving track. In a third manufacturing step, the hair-entry openings are formed in the annular shaving track by means of a milling process. In a fourth manufacturing step, the inner surface and the outer surface of the annular shaving track are processed by means of a polishing process.

Hair-cutting appliances as defined in the foregoing are normally made in mass production. In view thereof, there is an ongoing desire to simplify manufacturing processes of the various components of the hair-cutting appliances, including the guard element and the hair-cutting element of the hair-cutting units, so that manufacturing costs can be saved and possibly also other benefits can be achieved.

### SUMMARY OF THE INVENTION

In view of the foregoing, the invention provides a method of manufacturing a guard element which is configured to be used in a hair-cutting unit as a guard for a movable hair-cutting element of the hair-cutting unit, and which is of a design including a shaving track with a plurality of hair-entry apertures, the shaving track having a thickness profile with at least one thickness value, the method comprising an initial step of providing a sheet from which the guard element is to be formed, and the method comprising steps aimed at creating the shaving track according to the design of the guard element in the sheet, including a thickness-adapting step of realizing the at least one thickness value of the thickness profile of the shaving track according to the design of the guard element in the sheet at a position where the shaving track is to be formed, and a material-removing step of removing material from the sheet at the position where the shaving track is to be formed so as to form the hair-entry apertures, wherein the thickness-adapting step is performed earlier than the material-removing step.

It follows from the above definition that in the manufacturing process of a guard element according to the invention, a step aimed at providing the shaving track with a thickness profile according to the design of the guard element is already performed before the hair-entry apertures are formed. As a result, when the invention is put to practice, it is achieved that there is no need for any thickness-adapting action as finishing action on a near-final product which has already been provided with the hair-entry apertures. In this way, the invention provides a manufacturing method which may include less steps than a conventional manufacturing method according to which there is always (further) thickness adaptation to be done after the hair-entry apertures have been formed. Moreover, it has been found in the context of the invention that it is possible to rely on cold forming techniques only for the purpose of realizing the thickness profile of the shaving track, whereas the art teaches a necessity of applying techniques such as grinding or polishing after cold forming.

The material-removing step by means of which the hair-entry apertures are formed may involve any suitable action. For example, the sheet may be subjected to a cutting action such as stamping, as is commonly known in the field of hair-cutting appliances.

It may be so that in the design of the guard element, the thickness profile of the shaving track has different thickness values at different areas of the shaving track, although this is not essential in the context of the invention. In fact, any thickness profile of the shaving track can be realized when the invention is put to practice, including a thickness profile having only a single thickness value, in which case the shaving track substantially has the same thickness in each area thereof. In case different thickness values are to be realized at different areas of the shaving track, it may be so that one thickness value is obtained by actively reducing an initial thickness value while another thickness value is already found in the sheet from which the guard element is to be formed during the initial step of providing the sheet. In other words, it may be so that different thickness values are created by subjecting one area of the sheet at the position where one area of the shaving track is to be formed to a thickness-reducing action while leaving another area of the sheet at the position where another area of the shaving track is to be formed as it is.

It follows from the foregoing that the thickness-adapting step may particularly comprise a practical action of reducing the thickness of the sheet at a position where at least an area of the shaving track is to be formed. In this respect, it is noted that the thickness-adapting step may comprise an action of subjecting the sheet to a cold forming process at a position where at least an area of the shaving track is to be formed. For example, the thickness-adapting step may comprise an action of applying pressure to the sheet and/or flattening the sheet at a position where at least an area of the shaving track is to be formed. For the sake of clarity, it is noted that performing the thickness-adapting step may involve several actions, which actions may include cold forming actions as mentioned, but may also include material-removing actions such as grinding and/or polishing.

The method according to the invention may be applied for the purpose of manufacturing a guard element of a design according to which the shaving track is annular about a central axis of the guard element. In such a case, the method may comprise at least one of an outside bending step of bending the sheet at a position of an annular section of the sheet where an outer peripheral edge of the shaving track is to be formed and an inside bending step of bending the sheet at a position of an annular section of the sheet where an inner peripheral edge of the shaving track is to be formed, wherein both the thickness-adapting step and the material-removing step are performed earlier than at least one of the outside bending step and the inside bending step. It is generally known that for the purpose of effectively catching hairs to be cut off, it is beneficial if the outer surface of the guard element is convexly curved at the position of at least the outer peripheral edge of the shaving track, and a run-in portion of the hair-entry apertures is present in at least the outer peripheral edge of the shaving track. Further, the guard element can be of a design according to which the shaving track has a generally elevated position on the guard element, so that a skin area to be subjected to a hair-cutting action is in fact only contacted by the guard element at the position of the shaving track during use of a hair-cutting appliance having one or more hair-cutting units in which the guard element is included, in which case it is practical for the outer surface of the guard element to be convexly curved at both the position of the outer peripheral edge of the shaving track and the position of the inner peripheral edge of the shaving track.

Any feasible thickness profile of the shaving track can be realized by applying the invention. For example, it may be so that during the thickness-adapting step, a thickness distribution is realized in the sheet in which the thickness value at the position of one section of the sheet where a relatively thick area of the shaving track is to be formed is at least twice as large as the thickness value at the position of another section of the sheet where a relatively thin area of the shaving track is to be formed, but that does not alter the fact that the invention is also suitable to be applied for the purpose of realizing a thickness profile of the shaving track in which the difference between a relatively thick area of the shaving track and a relatively thin area of the shaving track is smaller, or a constant thickness profile of the shaving track which does not require realizing a thickness distribution in the sheet. In any case, it may be practical for the sheet which is provided in the initial step to be a sheet having a substantially uniform thickness, although the invention also covers an option of providing a sheet having some kind of initial thickness distribution which is to be transformed to another thickness distribution during the thickness-adapting step. Further, it is noted with respect to the sheet that the sheet may initially be of a planar shape, but that this is not essential within the framework of the invention.

According to a practical option, the guard element is of a design according to which the shaving track is annular about a central axis of the guard element, wherein further elongated lamellae are present between the hair-entry apertures, the lamellae having a thickness distribution in which the thickness value at outer end sections of the respective lamellae is larger than the thickness value at main sections of the respective lamellae. In such a case, it is advantageous if the thickness-adapting step involves realizing the thickness values of the thickness distribution of the lamellae according to the design of the guard element in the sheet at the position where the shaving track is to be formed, the thickness value of the outer end sections of the respective lamellae being realized at an annular section of the sheet where the outer end sections of the respective lamellae are to be formed, and the thickness value of the main sections of the respective lamellae being realized at an annular section of the sheet where the main sections of the respective lamellae are to be formed. For example, during the thickness-adapting step, the sheet may be subjected to a flattening action at the position of the annular section of the sheet where the main sections of the respective lamellae are to be formed, while no thickness-reducing action is taken at the position of the annular section of the sheet where the outer end sections of the respective lamellae are to be formed.

In conformity with what has been suggested earlier, it is possible to perform an action of bending the sheet at a position where the outer end sections of the respective lamellae are to be formed after both the thickness-adapting step and the material-removing step have been performed. Further, it may be so that in the design of the guard element, the thickness value at inner end sections of the respective lamellae is also larger than the thickness value at the main sections of the respective lamellae, in which case it is practical if during the thickness-adapting step, the thickness value of the inner end sections of the respective lamellae is realized at an annular section of the sheet where the inner end sections of the respective lamellae are to be formed. It may be so that the thickness value of the outer end sections of the respective lamellae and the thickness value of the inner end sections of the respective lamellae, respectively, are at least twice as large as the thickness value of the main sections of the respective lamellae, but other relations of the various thickness values are possible as well.

The method according to the invention may further comprise a shaving track-bulging step which involves providing at least an area of the shaving track with an outwardly bulged shape. Having an outwardly bulged shape of at least an area of the shaving track is believed to be advantageous in improving user comfort, and also in improving effectiveness of a hair-cutting action by better conforming to the skin of a user while reducing doming effects. The shaving track-bulging step may be performed later than the material-removing step, but this is not essential within the framework of the invention. In view of the foregoing, it is noted that an example of a guard element comprising lamellae having relatively thick end sections and a relatively thin main section is known from WO 2013/104965 A1. In this respect, WO 2013/104965 A1 discloses that an overall thickness of the guard element and the shaving track may be in the order of 70-150 microns, whereas the main section of the shaving track may have a thickness of 60 microns or less. The guard element is intended to be used in a shaving appliance and the thickness profile of the shaving track is chosen so as to have increased shaving closeness while preventing increased risk of skin entry in the hair-entry apertures. Also, WO 2013/104965 A1 discloses the possibility of having a domed outer surface of the shaving track.

The invention further relates to a method of manufacturing a hair-cutting unit comprising a guard element and a movable hair-cutting element at least partially arranged in an interior space of the guard element, wherein the guard element is manufactured by means of the method as mentioned here before. Also, the invention relates to a method of manufacturing a hair-cutting appliance comprising a body for a user of the hair-cutting appliance to take hold of and a head including at least one hair-cutting unit, wherein the hair-cutting unit is manufactured by means of the method as mentioned here before.

The above-described and other aspects of the invention will be apparent from and elucidated with reference to the following detailed description of a guard element for use in a hair-cutting unit of a hair-cutting appliance, particularly a shaving appliance, and steps of a method of manufacturing such a guard element.

### BRIEF DESCRIPTION OF THE DRAWINGS

The invention will now be explained in greater detail with reference to the figures, in which equal or similar parts are indicated by the same reference signs, and in which:

FIG. 1 diagrammatically shows a perspective view of a hair-cutting appliance manufactured by means of a method according to the invention;

FIG. 2 diagrammatically shows a perspective view of a guard element of a hair-cutting unit of the hair-cutting appliance;

FIG. 3 diagrammatically shows a sectional view of a portion of the guard element;

FIG. 4 is a detail of FIG. 3 and shows a sectional view of a shaving track of the guard element; and

FIGS. 5-9 illustrate various steps of a method of manufacturing the guard element, particularly steps aimed at producing the shaving track of the guard element.

### DETAILED DESCRIPTION OF THE EMBODIMENTS

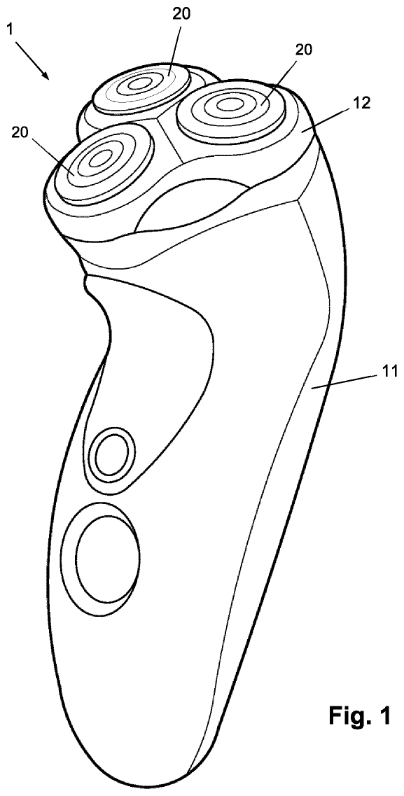

FIG. 1 relates to a hair-cutting appliance manufactured by means of a method according to the invention. In the figure, a shaving appliance 1 is shown, which comprises a body 11 and a head 12. The head 12 may be removably or hingably mounted to the body 11. The body 11 of the shaving appliance 1 is also commonly referred to as handle. In the shown example, three hair-cutting units 20 are disposed in the head 12, which does not alter the fact that another number of hair-cutting units 20 may be chosen, ranging from one to more than three.

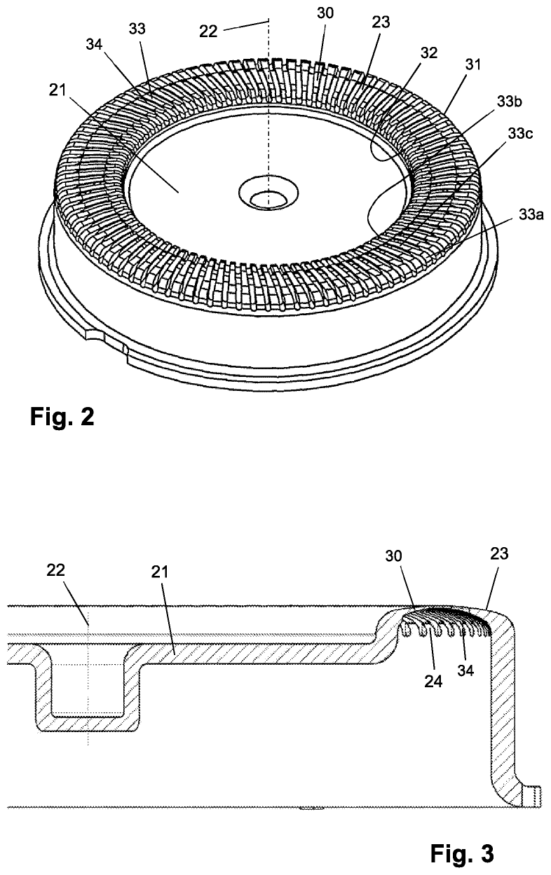

FIGS. 2-4 relate to a guard element 21 which is part of a hair-cutting unit 20 besides a hair-cutting element (not shown in the figures). The shaving appliance 1 as shown is of the rotary type, which implies that the hair-cutting element is arranged so as to be rotatable in the hair-cutting unit 20. For the sake of clarity, it is noted that possible applications of the invention are not restricted to the context of appliances including one or more rotatable hair-cutting elements. Also, it is noted that the guard element 21 as will now be described is only one of numerous embodiments which are covered by the invention, and that details of the design of this particular guard element 21 which are outside of the basic definition of the guard element provided in the claims are not to be understood so as to be limiting to the invention, wherein it is further noted that details which may be considered independently by a skilled person are not to be understood so as to be inextricably correlated even though they are disclosed with reference to a single example, unless an indication to the contrary is explicitly given.

The guard element 21 is of a generally cup-shaped design, having a substantially circular periphery, a central axis 22, and an outer surface 23. The guard element 21 is provided with an annular shaving track 30 for contacting the skin of a user during a shaving action, the shaving track 30 having two concentrically arranged peripheral edges 31, 32, namely an outer peripheral edge 31 and an inner peripheral edge 32. The guard element 21 further comprises lamellae 33 extending along the entire width of the shaving track 30 between the peripheral edges 31, 32, in a substantially radial direction with respect to the central axis 22 of the guard element 21. Each lamella 33 has an outer end section 33a at the position of the outer peripheral edge 31 of the shaving track 30, an inner end section 33b at the position of the inner peripheral edge 32 of the shaving track 30, and a main section 33c at an intermediate position between the end sections 33a , 33b . Apertures as present between the lamellae 33 constitute hair-entry apertures 34 of the shaving track 30. Sides of the lamellae 33 constitute cutting surfaces suitable for cutting off hairs in cooperation with cutting edges of the hair-cutting element.

A hair-cutting action is performed when the hair-cutting element of each of the hair-cutting units 20 is activated to rotate and the head 12 of the shaving appliance 1 is moved over a skin area from which hairs are protruding. In the process, the skin area is actually contacted by the guard elements 21 of the respective hair-cutting units 20. In each of the guard elements 21, the contact between the skin and the guard element 21 is particularly established at the position of the shaving track 30. During the movement of the head 12 of the shaving appliance 1 over the skin area, the hairs protruding from the skin area are caught in the hair-entry apertures 34 of the guard element 21 and are cut off in that position as result of a cooperation between the cutting surfaces as present at the sides of the lamellae 33 delimiting the hair-entry apertures 34 and the cutting edges of the rotating hair-cutting element.

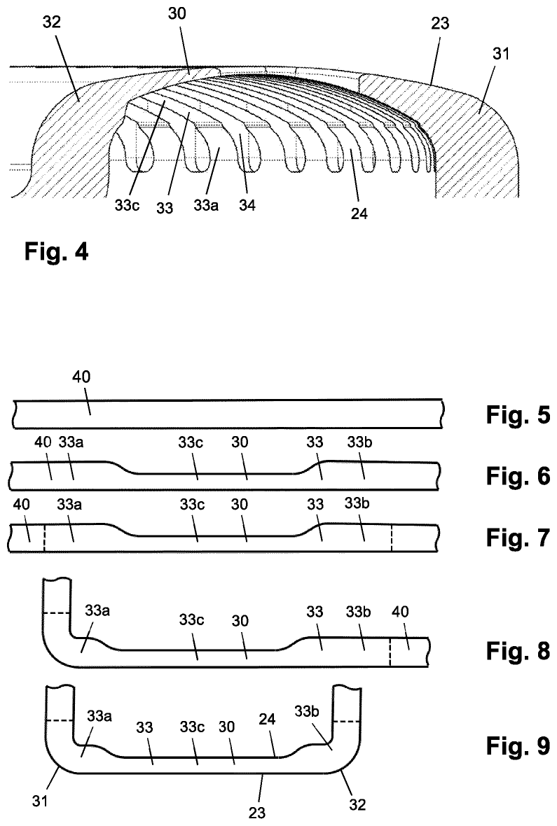

In the shown example, the outer surface 23 of the guard element 21 is slightly domed or toroidal in shape at the position of the shaving track 30. Nevertheless, it will be understood that the invention is equally applicable in the context of guard elements 21 of which the outer surface 23 is planar or has another shape than domed or toroidal at the position of the shaving track 30. Further, in the shown example, an inner surface 24 of the guard element 21 is also domed at the position of the shaving track 30. As can be seen in FIGS. 3 and 4, the curvature of the inner surface 24 of the guard element 21 at the position of the shaving track 30 is different from the curvature of the outer surface 23 of the guard element 21 at the same position, as a result of which the shaving track 30 has a thickness profile with different thickness values, wherein the lowest thickness values apply to an annular area of the shaving track 30 where the main sections 33c of the respective lamellae 33 are located, and wherein the highest thickness values apply to annular areas of the shaving track 30 where the respective end sections 33a , 33b of the respective lamellae 33 are located. For example, the first thickness values may be 100 microns or less, while the latter thickness values may be considerably larger, at least twice as large, such as in the order of 200 microns.

According to the invention, producing the shaving track 30 with a thickness profile such as indicated in the foregoing involves a specific order of steps as will now be described with reference to FIGS. 5-9.

FIG. 5 relates to an initial step and diagrammatically shows a sectional view of a portion of a sheet 40 which is provided in this step for the purpose of forming the guard element 21. The portion of the sheet which is shown is a portion where the shaving track 30 of the guard element 21 is to be formed. In the shown example, the sheet 40 is initially planar and is of constant thickness.

FIGS. 6-9 illustrate how the portion of the sheet 40 is transformed into the shaving track 30. Each of the figures show a sectional view of the sheet 40/shaving track 30 in the making, wherein it is to be noted that such a view is representative of what happens along an entire annular area of the sheet 40/shaving track 30 in the making.

FIG. 6 relates to a first subsequent step, and it follows from a comparison of FIG. 6 to FIG. 5 that the first subsequent step involves realizing a thickness reduction in an annular section of the sheet 40 where the main sections 33c of the respective lamellae 33 are to be formed. This thickness reduction can be realized in any suitable way, such as by applying cold forming techniques.

FIG. 7 relates to a second subsequent step, which step involves forming the hair-entry apertures 34, which can be done in various ways by any suitable technique adapted to remove material from the sheet 40 at appropriate places, which may be a cutting technique such as stamping, as suggested earlier. Ends of the hair-entry apertures 34 are diagrammatically indicated in FIG. 7 by means of dashed lines, and also in FIGS. 8 and 9.

FIGS. 8 and 9 relate to a third subsequent step, which step involves bending the sheet 40 at a position where the outer end sections 33a of the respective lamellae 33 are to be formed and bending the sheet 40 at a position where the inner end sections 33b of the respective lamellae 33 are to be formed. The two bending actions as mentioned may be performed simultaneously or one after another. Performing a bending action at the position of only one of the outer end sections 33a and the inner end sections 33b of the respective lamellae 33 is also possible within the framework of the invention. It will be understood that the exact nature of the third subsequent step is determined by the design of the guard element 21. On the other hand, depending on the design of the guard element 21, it may not be necessary to have the third subsequent step.

It follows from the foregoing that the first subsequent step is a thickness-adapting step aimed at creating the thickness profile of the shaving track 30 according to the design of the guard element 21 in the sheet 40, that the second subsequent step is a material-removing step aimed at creating the hair-entry apertures 34 of the shaving track 30, and that the optional third subsequent step is a bending step aimed at realizing a curved appearance at one or both of the outer peripheral edge 31 of the shaving track 30 and the inner peripheral edge 32 of the shaving track 30. In view of the fact that the thickness profile of the shaving track 30 according to the design of the guard element 21 is realized as a result of performing the first subsequent step, there is no need for performing any further specific thickness-adapting action once the first subsequent step has been performed and the second subsequent step is initiated, and this is therefore not done when the invention is applied. Thus, according to the invention, (a) thickness-adapting action(s) is/are taken and finished first before the hair-entry apertures 34 are made. Any bending action as mentioned in the foregoing in respect of the third subsequent step is performed no earlier than that both the thickness-adapting step and the material-removing step have taken place.

The manufacturing process of the guard element 21 may involve other steps than the above-mentioned initial step, first subsequent step, second subsequent step and optional third subsequent step, which steps may be performed as intermediate steps and/or finishing steps in the process. The term “subsequent” as used in the present text in respect of a step should be understood so as to mean a later step, which is not necessarily the same as a step immediately following a step identified as an earlier step in the process. An example of a step which may be performed as a finishing step is a step aimed at realizing an outwardly bulged shape, i.e. a domed or toroidal shape, of at least an area of the shaving track 30, as mentioned earlier.

It will be clear to a person skilled in the art that the scope of the invention is not limited to the examples discussed in the foregoing, but that several amendments and modifications thereof are possible without deviating from the scope of the invention as defined in the attached claims. It is intended that the invention be construed as including all such amendments and modifications insofar they come within the scope of the claims or the equivalents thereof. While the invention has been illustrated and described in detail in the figures and the description, such illustration and description are to be considered illustrative or exemplary only, and not restrictive. The invention is not limited to the disclosed embodiments. The drawings are schematic, wherein details which are not required for understanding the invention may have been omitted, and not necessarily to scale.

Variations to the disclosed embodiments can be understood and effected by a person skilled in the art in practicing the claimed invention, from a study of the figures, the description and the attached claims. In the claims, the word “comprising” does not exclude other steps or elements, and the indefinite article “a” or “an” does not exclude a plurality. Any reference signs in the claims should not be construed as limiting the scope of the invention.

Elements and aspects discussed for or in relation with a particular embodiment may be suitably combined with elements and aspects of other embodiments, unless explicitly stated otherwise. Thus, the mere fact that certain measures are recited in mutually different dependent claims does not indicate that a combination of these measures cannot be used to advantage.

The terms “comprise” and “include” as used in this text will be understood by a person skilled in the art as covering the term “consist of”. Hence, the term “comprise” or “include” may in respect of an embodiment mean “consist of”, but may in another embodiment mean “contain/have/be equipped with at least the defined species and optionally one or more other species”.

The guard element 21 as described on the basis of the figures comprises a single shaving track 30. That does not alter the fact that the invention is also applicable to guard elements 21 comprising more than one shaving track, wherein the concept of taking all actions aimed at realizing an intended thickness profile of the shaving track prior to creating the hair-entry apertures 34 of the shaving track may be applied to one or more of those shaving tracks. In this respect, it is noted that an example of a guard element 21 comprising as many as three shaving tracks is known from WO 2008/152590 A1.

Further, it is not essential for the guard element 21 according to the invention to comprise more or less elongated lamellae 33 extending all the way between the peripheral edges 31, 32 of the shaving track 30. For example, options of having a shaving track 30 in which the hair-entry apertures 34 have a substantially circular shape and having a shaving track 30 in which a combination of longer lamellae bridging the entire width of the shaving track 30 and shorter lamellae extending as teeth along only a portion of the width of the shaving track 30 is used are also covered by the invention. In general, in case lamellae are included in the design of the shaving track 30, such lamellae may be of any suitable shape, and may include a bifurcation, for example.

In respect of the suggestion that during the thickness-adapting step, the at least one thickness value of the thickness profile of the shaving track 30 according to the design of the guard element 21 is realized in the sheet 40 at a position where the shaving track 30 is to be formed, it is noted that this is to be understood for its practical meaning rather than its theoretical meaning, taking into account that in practice a tolerance window is applicable when it comes to realizing values.

Notable aspects of the invention can be summarized as follows. In a method of manufacturing a guard element 21 which is configured to be used in a hair-cutting unit 20 as a guard for a movable hair-cutting element of the hair-cutting unit 20, and which is of a design including a shaving track 30 with a plurality of hair-entry apertures 34, the shaving track 30 having a thickness profile with at least one thickness value, a number of steps is performed in a certain order. In an initial step, a sheet 40 is provided from which the guard element 21 is to be formed. In a first subsequent step, the at least one thickness value of the thickness profile of the shaving track 30 according to the design of the guard element 21 is realized in the sheet 40 at a position where the shaving track 30 is to be formed. In a second subsequent step, material is removed from the sheet 40 at the position where the shaving track 30 is to be formed so as to create the hair-entry apertures 34.

1. A method of manufacturing a guard element, wherein the guard element is configured to be used in a hair-cutting unit as a guard for a movable hair-cutting element of the hair-cutting unit, and wherein a design of the guard element includes a shaving track having a plurality of hair-entry apertures the method comprising:
an initial step of providing a sheet from which the guard element is to be formed,
a thickness-adapting step of realizing a thickness profile of the shaving track according to the design of the guard element in the sheet at a position where the shaving track is to be formed, wherein the thickness profile has at least one thickness value; and
a material-removing step of removing material from the sheet at the position where the shaving track is to be formed so as to form the hair-entry apertures,
wherein the thickness-adapting step is performed prior to the material-removing step,
whereby performing the initial step, the thickness-adapting step, and the material-removing step creates the shaving track in the sheet according to the design of the guard element.

2. The method according to claim 1, wherein, in the design of the guard element, the thickness profile of the shaving track has different thickness values at different areas of the shaving track.

3. The method according to claim 1, wherein the thickness-adapting step comprises reducing the thickness of the sheet at a position where at least portion of shaving track is to be formed.

4. The method according to claim 1, wherein the thickness-adapting step comprises subjecting the sheet to a cold forming process at a position where at least portion of the shaving track is to be formed.

5. The method according to claim 1, wherein the thickness-adapting step comprises applying pressure to the sheet and/or flattening the sheet at a position where at least a portion of the shaving track is to be formed.

6. The method according to claim 1, wherein, in the design of the guard element, the shaving track is annular about a central axis of the guard element, the method comprising at least one of:
an outside bending step of bending the sheet at a position of an annular section of the sheet where an outer peripheral edge of the shaving track is to be formed, and
an inside bending step of bending the sheet at a position of an annular section of the sheet where an inner peripheral edge of the shaving track to be formed,
wherein both the thickness-adapting step and the material-removing step are performed prior to at least one of the outside bending step and the inside bending step.

7. The method according to claim 1, wherein the thickness-adapting step further comprises realizing a thickness distribution in the sheet in which the thickness value at a position of a first section of the sheet where a relatively thick area of the shaving track is to be formed is at least twice as large as the thickness value at position of a second section of the sheet where a relatively thin area of the shaving track is to be formed.

8. The method according to claim 1, wherein:
in the design of the guard element, the shaving track is annular about a central axis of the guard elennent,
elongated lamellae are present between the hair-entry apertures, the lamellae having a thickness distribution in which the thickness value at outer end sections of the respective lamellae is larger than the thickness value at main sections of the respective lamellae, and
the thickness-adapting step s realizing the thickness values of the thickness distribution of the lamellae according to the design of the guard element in the sheet at the position where the shaving track is to be formed, the thickness value of the outer end sections of the respective lamellae being realized at an annular section of the sheet where the outer end sections of the respective lamellae are to be formed, and the thickness value of the main sections of the respective lamellae being realized at an annular section of the sheet where the main sections of the respective lamellae are to be formed.

9. The method according to claim 8, wherein, after both the thickness-adapting step and the material-removing step have been performed, the sheet is bent at a position where the outer end sections of the respective lamellae are to be formed.

10. The method according to claim 8, wherein:
in the design of the guard element, the thickness value at inner end sections of the respective lamellae is also larger than the thickness value at the main sections of the respective lamellae,
the thickness-adapting step further comprises realizing the thickness value of the inner end sections of the respective lamellae at an annular section of the sheet where the inner end sections of the respective lamellae are to be formed.

11. The method according to claim 1, further comprising a shaving track-bulging step of providing at least an area of the shaving track with an outwardly bulged shape.

12. The method according to claim 1, wherein the sheet provided in the initial step is a sheet having a substantially uniform thickness.

13. The method according to claim 1, wherein the material-removing step is performed by cutting the sheet.

14. A method of manufacturing a hair-cutting unit comprising the guard element and the movable hair-cutting element at least partially arranged in an interior space of the guard element, wherein the guard element is manufactured by the method according to claim 1.

15. A method of manufacturing a hair-cutting appliance comprising a body for a user of the hair-cutting appliance to hold and a head including at least one hair-cutting unit, wherein the at least one hair-cutting unit includes the hair-cutting unit manufactured by t he method according to claim 14.
